(19) United States
(12) Patent Application Publication
(10) Pub. No.: US 2026/0024738 A1
(43) Pub. Date: Jan. 22, 2026

(54) A CHARGE DETECTION MASS SPECTROMETRY (CDMS) DEVICE

(71) Applicant: Micromass UK Limited, Wilmslow (GB)

(72) Inventors: David J. Langridge, Mcclesfield (GB); Keith Richardson, High Peak (GB)

(73) Assignee: Micromass UK Limited, Wilmslow (GB)

(21) Appl. No.: 18/998,049

(22) PCT Filed: Jul. 27, 2023
(86) PCT No.: PCT/GB2023/051995

§ 371 Date: Jan. 23, 2025

(30) Foreign Application Priority Data
Jul. 28, 2022 (GB) 2211029.0

(51) Int. Cl. H01J 49/42; H01J 49/00; H01J 49/06; H01J 49/40

(52) U.S. Cl. CPC H01J 49/4245; H01J 49/0031; H01J 49/067; H01J 49/406

(57) ABSTRACT

A charge detection mass spectrometry (CDMS) device comprising: an ion trap for receiving an ion flux and configured for selectively trapping and analysing one or more ions of interest from the ion flux, and at least one primary charge detector. positioned upstream of the ion trap in the path of the ion flux, to analyse the ion flux, wherein the device is configured such that the analysis by the at least one primary charge detector is used to selectively initiate an ion trapping event in the ion trap.

### FIELD

The present invention relates to a charge detection mass spectrometry (CDMS) device and an associated method.

### BACKGROUND

Charge detection mass spectrometry (CDMS) enables the characterisation of large, highly-charged and heterogeneous analytes, such as whole virus capsids, that are of increasing importance in next-generation biotheraputics.

CDMS analysis is usually carried out in electrostatic ion traps. Ions oscillate back and forth between two reflectrons (effectively acting as ion mirrors), repeatedly passing a central charge-detection electrode. For a given trap geometry and known ion energy, the mass-to-charge ratio (m/z) of an ion can be determined from its oscillation frequency, while the measured signal amplitude can be used to determine the charge (z) on the ion. The product of m/z and z yields the ion mass.

In order to achieve an acceptable charge accuracy (unit charge, in some cases), long trapping times, for example hundreds of milliseconds, may be required. One consequence of this is that when two or more ions of the same energy are trapped simultaneously, there is a high probability that they will interact with one another. These interactions change the energies of the ions, complicating the interpretation of the resulting data. The use of traditional data analysis methods (e.g. Fast Fourier Transforms (FFT)) may result in a reduction in the effective mass resolution of the CDMS device.

To try and mitigate a reduction in resolution, CDMS devices may be operated in single-ion mode. However, this then increases the time required to build up a mass spectrum. For some applications adopting a single-ion mode, it can take many hours to achieve the required data quality. This problem may be exacerbated by the fact that, even with careful control of the incoming ion flux, many attempted trapping events may result in no trapped ions at all; or the trapping of multiple ions. Indeed, even when the ion arrival rate is optimised for single-ion trapping operation, the success rate may be no higher than about 37%, in a random-trapping mode of operation.

Incoming ions pass through the detection electrode before reflection by the end reflectron (mirror electrodes). One method of increasing the success rate may be to operate the trap in triggered-trapping mode. In this mode, the reflectron at the entrance to the ion trap is initially operated in a transmission mode, allowing the passage of the ion flux therethrough. A successful ion trapping event (ie raising the potential on the electrodes of the reflectron at the entrance) is conditional on the observation of a sufficiently intense signal at the detection electrode. While this mode can lead to a significantly higher success rate (up to 90%) than single-ion trapping, it is dependent on favourable conditions. In particular, there is a need to be able to distinguish the single pass ion signal from background electrical noise. This has generally restricted successful application of this technique to highly charged ions.

Moreover, in this mode, the trigger signal is obtained from the detection electrode, which is necessarily situated between the front and end reflectrons, ie in the trapping region. Thus the time available to signal process the trigger signal and switch voltages (to a trapping mode) is relatively short, comprising the turn around time in the end electrodes and the return transit time through the detection electrode.

### BRIEF DESCRIPTION OF THE INVENTION

The present invention provides a charge detection mass spectrometry (CDMS) device comprising: an ion trap for receiving an ion flux and configured for selectively trapping and analysing one or more ions of interest from the ion flux, and at least one primary charge detector, positioned upstream of the ion trap in the path of the ion flux, to analyse the ion flux, wherein the device is configured such that the analysis by the at least one primary charge detector is used to selectively initiate an ion trapping event in the ion trap.

In at least one embodiment, the trapping event comprises trapping a detected one or more ions of interest in the ion trap.

In at least one embodiment, the distance between the primary charge detector and the ion trap is equal to or greater than the axial length of the ion trap.

In at least one embodiment, the ion trap comprises a secondary charge detector, for analysing one or more ions of interest trapped in the ion trap.

In at least one embodiment, the secondary charge detector is operable to analyse the ion flux and wherein the analysis by the at least one primary charge detector and the secondary charge detector is used to selectively initiate the ion trapping event in the ion trap.

In at least one embodiment, the inner diameter of the primary charge detector is smaller than the inner diameter of the secondary charge detector.

In at least one embodiment, the axial length of the primary charge detector is smaller than the axial length of the secondary charge detector.

In at least one embodiment, the primary charge detector comprises a plurality of detector electrodes.

In at least one embodiment, the axial length and/or inner diameter of at least one of the plurality of detector electrodes of the primary charge detector differs to the axial length and/or inner diameter of the or another of the plurality of detector electrodes of the primary charge detector.

In at least one embodiment, the primary charge detector comprises at least three detector electrodes axially spaced asymmetrically.

In at least one embodiment, the device comprises a first electrostatic lens located upstream of the primary charge detector and a second electrostatic lens located between the primary charge detector and the ion trap.

In at least one embodiment, the charge detection mass spectrometry (CDMS) device further comprises a controller operatively connected to the ion trap and the primary charge detector, the controller configured to detect one or more ions of interest passing the primary charge detector and to send a trigger signal to the ion trap to initiate the ion trapping event.

In at least one embodiment, the ion trap comprises a first reflectron and a second reflectron, and the trapping event comprises increasing the potential of the first and/or second reflectrons to trap said one or more ions of interest in the ion trap.

In at least one embodiment, the ion flux is received in the ion trap through the first reflectron, the first reflection being selectively operable in a transmission mode, allowing the passage of ions therethrough, and a trapping mode, substantially preventing the passage of ions therethrough, wherein the initiation of the trapping event comprises changing the first reflectron from said transmission mode to said trapping mode.

In at least one embodiment, the charge detection mass spectrometry (CDMS) device further comprises a secondary charge detector between the first and second reflectrons, for analysing one or more ions of interest trapped in the ion trap.

The present invention further provides a method of charge detection mass spectrometry (CDMS) comprising: providing an ion trap, and a primary charge detector upstream of the ion trap; passing an ion flux through the primary charge detector and ion trap; analysing the ion flux at the primary charge detector for one or more ions of interest; and initiating an ion trapping event in the ion trap based on the analysis of the ion flux at the primary charge detector.

In at least one embodiment, the ion trap comprises a first reflectron and a second reflectron, and initiating an ion trapping event comprises increasing the potential of the first and/or second reflectrons to trap said one or more ions of interest in the ion trap.

The present invention further provides a charge detection mass spectrometry (CDMS) device comprising: an ion trap for receiving an ion flux and configured for selectively trapping and analysing one or more ions from the ion flux, the ion trap comprising first and second reflectrons and at least one charge detector positioned between the first and second reflectrons, wherein at least one of the first and second reflectrons is configured to selectively operate in a first mode or a second mode, wherein the reflecting time of an ion from the reflectron in the first mode is longer than the reflecting time of that ion in the second mode, wherein the device is configured such that an output of the charge detector is used to selectively change the mode of the reflectron(s).

In at least one embodiment, the charge detection mass spectrometry (CDMS) device is configured to change the reflectron(s) from the first mode to the second mode upon detection by the charge detector of at least one ion of interest.

In at least one embodiment, at least one of the first and second reflectrons comprises first and second reflectron modules, the first reflectron module arranged between the charge detector and the second reflectron module,
the first reflectron module is selectively operable in a transmission mode, allowing the passage of ions therethrough, and a trapping mode, substantially preventing the passage of ions therethrough,
the second reflectron module configured to reflect any ions passing through the first reflectron module.

The present invention further provides a method of charge detection mass spectrometry (CDMS) comprising: providing an ion trap for receiving an ion flux and configured for selectively trapping and analysing one or more ions of interest from the ion flux, the ion trap comprising first and second reflectrons and at least one charge detector positioned between the first and second reflectrons, wherein one of the first and second reflectrons is configured to selectively operate in a first mode or a second mode, wherein the reflecting time of an ion from the reflectron in the first mode is longer than the reflecting time of that ion in the second mode; operating the reflection in the first mode; analysing the ion flux at the least one charge detector; changing the reflection to the second mode upon detection by the charge detector of at least one ion of interest.

### BRIEF DESCRIPTION OF THE FIGURES

In order that the present disclosure may be more readily understood, embodiments thereof will now be described, by way of example only, with reference to the accompanying drawings, in which:

FIG. 1 schematically illustrates a known CDMS device;

FIG. 2 schematically illustrates a CDMS device according to at least one embodiment of the claimed invention;

FIG. 3 schematically illustrates a primary charge detector of a device according to at least one embodiment of the claimed invention; and

FIG. 4 schematically illustrates a CDMS device according to another embodiment of the claimed invention;

### DETAILED DESCRIPTION OF THE DISCLOSURE

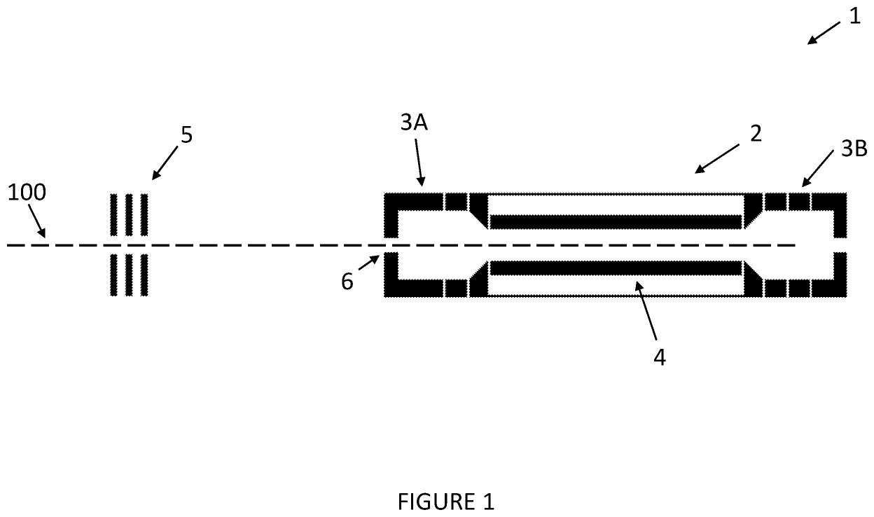

FIG. 1 schematically illustrates a known CDMS device 1 comprising an ion trap 2 configured to operate in a triggered-trapping mode as described above. The ion trap 2 comprises a first reflectron 3A and a second reflectron 3B. A charge detector 4 is arranged between the first reflectron 3A and second reflectron 3B. The first reflectron 3A and second reflectron 3B may each comprise a single-stage reflectron, each respectively defining an ion mirror which serves to reverse the direction of travel of ions entering into it.

An ion flux 100 is illustrated schematically in FIG. 1. An electrostatic lens 5 (e.g. an einzel lens) may be provided in the path of the ion flux 100, upstream of the ion trap 2, so as to selectively focus the ion flux 100 passing therethrough.

The ion flux 100, after passing through the electrostatic lens 5, enters the ion trap 2 through an entrance 6. The first reflectron 3A is selectively operable in a transmission mode, allowing the passage of ions therethrough, and a trapping mode, substantially preventing the passage of ions therethrough.

Initially, the first reflectron 3A is operated in a transmission mode. The second reflectron 3B is configured to reverse the direction of travel of ions entering into it and/or approaching it. The second reflectron 3B may be selectively operable in a transmission or trapping mode, as with the first reflectron 3A, but substantially always operated in a trapping mode. Alternatively, the second reflectron 3B may only be configured to reverse the direction of travel of ions entering into it, thus acting as an ion mirror.

The ion flux 100 is allowed to enter the entrance 6 and into the first reflectron 3A operating in a transmission mode. Consequently, the ion flux 100 passes through the first reflectron 3A, substantially unaffected by the first reflectron 3A. Next, the ion flux 100 passes through the charge detector 4. The charge detector 4 is able to analyse the ion flux 100 passing therethrough. Next, the ion flux 100 reaches the second reflectron 3B which, as noted above, serves to reverse the direction of travel of ions. The ion flux 100 is then directed back through the charge detector 4 and back towards the first reflectron 3A.

If the first reflectron 3A is still operated in a transmission mode, the ion flux 100 may substantially pass out of the entrance 6.

One or more ions of interest may be detected in the ion flux 100 as it passes through and is analysed by the charge detector 4. However, due to the speed of the ion flux 100 and/or the geometry of the ion trap 2, the first reflectron 3A may not be able to be reconfigured to a trapping mode in time before the ions of interest pass back through the first reflectron 3A and escape the ion trap 2.

In the known arrangement shown in FIG. 1, the electrostatic lens 5 is 50 mm from the entrance 6 to the ion trap 2. The axial length of each of the first 3A and second 3B reflectrons may be 25 mm, and the axial length of the charge detector 4 may be 50 mm. For an ion of m/z 1000 at 130 eV, transit through the charge detector 2 is in the order of 10 μsec (velocity is 5 mm/μsec), the time for the ion flux 10 to be reflected in the second reflectron 3B is of the same order, hence 10 μsec for one reflection. Therefore, the time available to detect an ion of interest, and to change the first reflectron 3A from a trapping mode to a trapping mode, is roughly equal to the time is takes for the ion flux 100 to be reflected by the second electron 3B and to pass back through the charge detector 2. In the example illustrated, this may be 20 μsec (10 μsec+10 μsec).

The time may not be enough to accurately analyse the ion flux (to verify that an ion of interest is present) and/or to change the first reflectron 3A from transmission mode to trapping mode. Consequently, an ion of interest may not be trapped in time; and/or the device may initiate an ion trapping event based on an inaccurate/incomplete analysis of the ion flux 100.

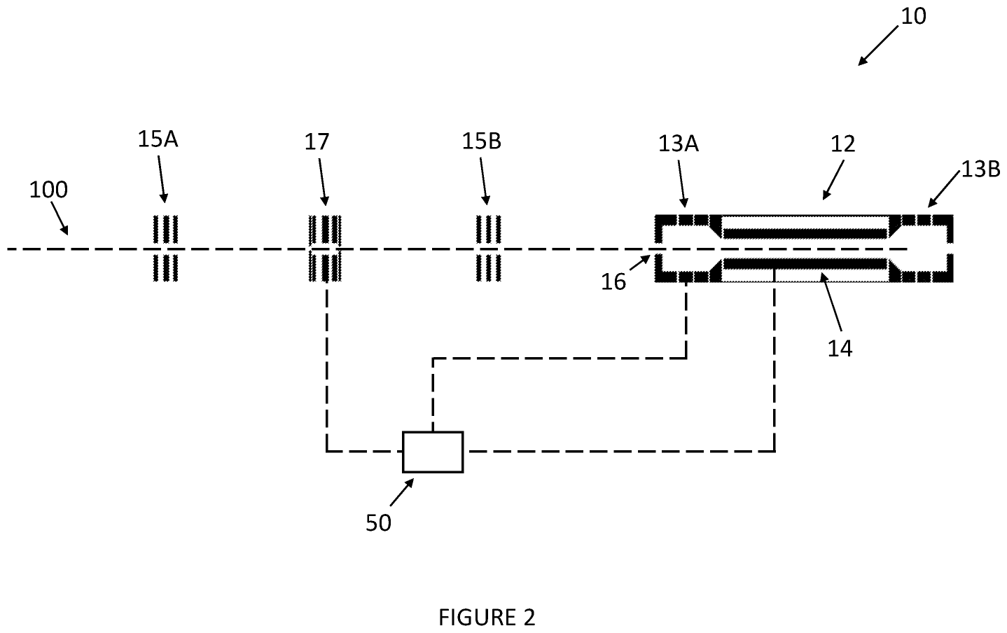

Accordingly, as illustrated in FIG. 2, the claimed invention provides a charge detection mass spectrometry (CDMS) device 10 comprising an ion trap 12. The ion trap 12 is for receiving an ion flux 100 and configured for selectively trapping and analysing one or more ions of interest from the ion flux 100. The device 10 further comprises at least one primary charge detector 17, positioned upstream of the ion trap 12 in the path of the ion flux 100, to analyse the ion flux 100. The device 10 is configured such that the analysis by the at least one primary charge detector 17 is used to selectively initiate an ion trapping event in the ion trap 12.

The ion trap 12 may be substantially the same as the ion trap 2 described above and illustrated in FIG. 1, and so comprises a first reflectron 13A and a second reflection 13B with a charge detector 14 therebetween. However, in the ion trap 12 of the device 10 embodying the present invention, there are two charge detectors: a primary charge detector 17 upstream of the ion trap 12 and a secondary charge detector 14 in the ion trap 12, disposed between the first reflectron 13A and second reflectron 13B. The primary charge detector 17 is configured to analyse the ion flux 100 for at least one ion of interest, and the secondary charge detector 14 is configured to analyse the at least one ion of interest when trapped in the ion trap 12.

An advantage of providing the primary charge detector 17 upstream of the ion trap 12 is that it increases the time available to analyse the ion flux 100, detect an ion of interest, and change the mode of the first reflectron 13A from the transmission mode to a trapping mode (e.g. by switching the voltage of the first reflectron 13A) so that the ion of interest may subsequently be trapped in the ion trap 12.

The increase in available time may also allow for more sophisticated signal processing of the signal from the primary charge detector. For example, forward fitting may be implemented to provide a best-fit model of the signal, and/or upstream filtering may be used to provide more accurate information about the m/z or axial velocity/KE of an ion of interest.

A benefit of having both a primary and secondary charge detector is that the analysis by both the primary charge detector and the secondary charge detector may be used to selectively initiate the ion trapping event in the ion trap. For example, if one or more ions of interest is detected by the primary charge detector, the subsequent analysis by the secondary charge detector, as the/those ions pass therethrough, may be utilised to verify the analysis of the primary charge detector, and initiate the ion trapping event accordingly.

Further analysis can be performed using both the primary and secondary charge detectors. For example, the time difference between each of the primary and secondary charge detectors detecting a given ion may allow for an estimation of the mass to charge (m/z) ratio of the ion, since the distance between the primary and secondary detectors is known, and the energy of the ion may be known or estimated. The ion trapping event may be initiated only if the m/z of the detected ion is within a range of interest. This effectively provides a time of flight (TOF) experiment.

In the event that multiple ions are detected, each having a different m/z, the time between the ions being detected at the primary charge detector may be different to the time between the ions detected at the secondary charge detector. Two ions may arrive at the primary charge detector substantially simultaneously, only detectably separating by the time they reach the secondary charge detector. The analysis by the secondary charge detector therefore improves accuracy of the analysis of the ions. The time of arrival of one or more of the multiple detected ions at the ion trap may be estimated, and the trapping even initiated to selectively trap one or more of the detected ions.

In at least one embodiment, there is further provided at least one electrostatic lens 15, upstream of the ion trap 12, for selectively focussing the ion flux 100 passing therethrough. The electrostatic lens 15 may be upstream of the primary charge detector 17.

As illustrated in FIG. 2, the device may comprise a first electrostatic lens 15A located upstream of the primary charge detector 17 and a second electrostatic lens 15B located downstream of the primary charge detector 17. The second electrostatic lens 15B may be between the primary charge detector 17 and the ion trap 12, as illustrated.

In the example illustrated in FIG. 2, the primary charge detector 17 is 100 mm from the entrance 16 to the ion trap 12. The axial length of each of the first 13A and second 13B reflectrons may be 25 mm, and the axial length of the secondary charge detector 14 may be 50 mm—and thus similar to the geometry of the components of the ion trap 2 illustrated in FIG. 1.

The time between a given ion passing through the primary charge detector 17, then through the ion trap 12, and reflecting back therethrough, is significantly increased from the known arrangement illustrated in FIG. 1. With a primary charge detector 17 located 100 mm from the entrance 16 to the ion trap 12, the total time may be 55 μsec, which is nearly three times more than the total time of the known arrangement shown in FIG. 1.

The distance between the primary charge detector 17 and the ion trap 12 may be equal to or greater than the axial length of the ion trap.

The primary charge detector 17 may be located further upstream of the ion trap 12 or closer to the ion trap 12. The example described above assumes a substantially mono-energetic system. If the ion energy at the charge detector electrodes or elsewhere in the upstream optics is substantially less than the final energy in the detection tube, the available time to detect an ion of interest and change the mode of the first reflectron 13A from the transmission mode to a trapping mode would be increased further.

Further advantages may be gained through the provision of a primary charge detector 17 which is separate to the secondary charge detector 14 of the ion trap 12.

For example, as the function of the primary charge detector 17 may now be differentiated from that of the secondary charge detector 14, each charge detector 14, 17 may be optimised for its intended function. The primary charge detector 17, and the signal processing it carries out, may be optimised for detection of the at least one ion of interest, rather than being optimised for the recordal of CDMS data of the ion of interest when trapped in the ion trap 12 (i.e. a function of the secondary charge detector 14).

The charge detector electrode 4 of the known arrangement shown in FIG. 1 is generally relatively long, to achieve approximately equal time spent in the charge detector 4 vs the first and second reflectron 3A, 3B. This extended axial length of the charge detector 4 places limits on how narrow its internal diameter can be made while still obtaining stable trapping for ions with off-axis components of velocity. A separate, dedicated, charge detector positioned upstream of the ion trap, as with the primary charge detector 17 of a device 10 embodying the present invention, can be relatively short and thus have a narrower internal diameter. Consequently, ions will on average pass closer to the electrodes of the upstream primary charge detector 17. This allows for the upstream primary charge detector 17 to be relatively smaller.

In at least one embodiment, the inner diameter of the primary charge detector 17 is smaller than the inner diameter of the secondary charge detector 14. In at least one embodiment, the axial length of the primary charge detector 17 is smaller than the axial length of the secondary charge detector 12. In at least one embodiment, the inner diameter of the primary charge detector 17 is smaller than the inner diameter of the secondary charge detector 14 and the axial length of the primary charge detector 17 is smaller than the axial length of the secondary charge detector 12.

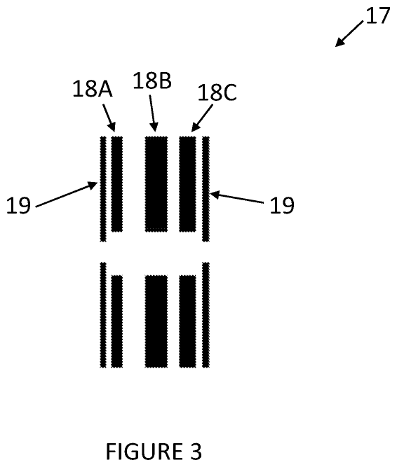

The primary charge detector 17 may comprise a plurality of detector electrodes 18A-18C, as illustrated in FIG. 3. The plurality of detector electrodes 18A-18C may be coaxially aligned in succession. By providing and analysing the signals from multiple detector electrodes 18A-18C, the signal-to-noise ratio may be increased.

An embodiment comprising a plurality of detector electrodes 18A-18C may allow for improved signal processing. For example, signal analysis may provide information about the m/z or axial velocity/KE of an ion of interest, or to identify multiple potential ions of interest if the incoming ions have sufficiently distinct velocities. Decoding the m/z or axial velocity/KE information may be enhanced with the use of upstream filtering, for example with a resolving quadrupole for m/z selection, or a hemispherical deflection analyser (HDA) for KE selection.

The plurality of detector electrodes 18A-18C may have substantially the same internal diameter and/or axial length, or they may differ.

The provision of dissimilar detector electrodes 18A-18C may yield differing signals from each electrode for a given ion. By knowing the relative differences between the detector electrodes 18A-18C, the resulting signal may effectively be decoded during signal processing.

In FIG. 3, the internal diameter of the first detector electrode 18A is larger than the internal diameter of the second 18B and third 18C detector electrodes. The axial length of the first detector electrode 18A is smaller than the axial length of the third detector electrode 18C which, in turn, is smaller than the axial length of the second detector electrode 18B.

Moreover, as illustrated in FIG. 3, detector electrodes 18A-18C are axially spaced asymmetrically. That is to say that the axial distance between the first detector electrode 18A and the second detector electrode 18B is different to the axial distance between the second detector electrode 18B and the third detector electrode 18C. This may further assist in decoding the received signals from each of the detector electrodes 18A-18C.

Still further, as illustrated in FIG. 3, shield electrodes 19 may be provided upstream and downstream of the primary charge detector 17, to reduce noise.

While the resolution of the ion flux 100 is likely to be low, by obtaining sufficient m/z and/or axial velocity/KE information from the primary charge detector 17, it is possible to selectively trap ions, i.e. choosing whether or not to trap on trigger events based on some criteria related to m/z or velocity.

In embodiments of the present invention, the primary charge detector 17 is used to selectively initiate an ion trapping event in the ion trap. An ion trapping event is when the primary charge detector 17 has detected that at least one ion of interest is present in the ion flux 100.

As schematically illustrated in FIG. 2, the device 10 may further comprise a controller 50 operatively connected to the ion trap 12 and the primary charge detector 17, the controller 50 configured to detect one or more ions of interest passing the primary charge detector 17 and to send a trigger signal to the ion trap 12 to initiate the ion trapping event. The controller 50 may be operatively connected to the first reflectron 13A and the secondary charge detector 14. When the controller 50 detects at least one ion of interest in the ion flux 100, the first reflectron 13A may be changed from the transmission mode to a trapping mode at the appropriate time, to trap the at least one ion of interest in the ion trap 12. The time between the detection of at least one ion of interest in the ion flux 100 and the changing of the mode of the first reflectron 13A from a transmission mode to a trapping mode is configured so as to be less than or equal to the time taken by the at least one ion to travel from the primary charge detector 17, through the ion trap 12, and back towards the first reflectron 13A.

A method of charge detection mass spectrometry (CDMS) is disclosed herein. The method comprises:
providing an ion trap 12, and a primary charge detector 17 upstream of the ion trap 12;
passing an ion flux 100 through the primary charge detector 17 and ion trap 12;
analysing the ion flux 100 at the primary charge detector 17 for one or more ions of interest; and
initiating an ion trapping event in the ion trap 12 based on the analysis of the ion flux 100 at the primary charge detector 17.

The ion trap 12 comprises a first reflectron 13A and a second reflectron 13B, and initiating an ion trapping event comprises changing at least one of the first 13A and/or second reflectrons 13B from a transmission mode to a trapping mode. This may comprise increasing the potential of the first 13A and/or second reflectrons 13B to trap said one or more ions of interest in the ion trap 12. The potential of the first 13A and/or second reflectrons 13B when in the transmission mode is low enough so as not to substantially disrupt the flow of the ion flux 100 therethrough.

Generally, embodiments of the present invention seek to increase the time available to adequately and accurately analyse the ion flux 100 to identify at least one ion of interest.

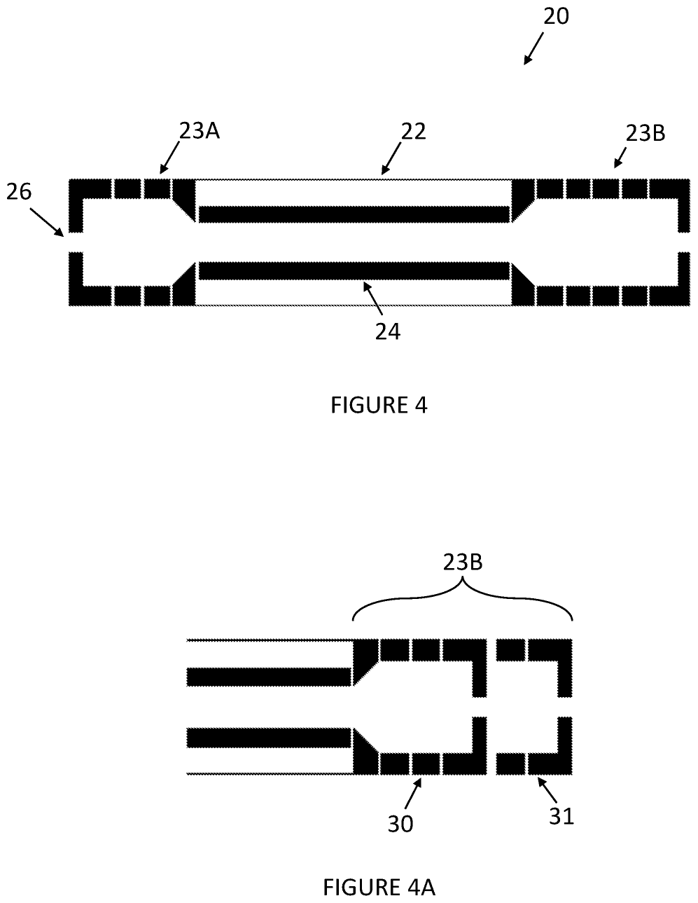

In another embodiment, as illustrated in FIG. 4, there is provided a charge detection mass spectrometry (CDMS) device 20 comprising:
an ion trap 22 for receiving an ion flux 100 and configured for selectively trapping and analysing one or more ions from the ion flux 100, the ion trap 22 comprising first 23A and second reflectrons 23B and at least one charge detector 24 positioned between the first 23A and second 23B reflectrons,
wherein at least one of the first 23A and second 23B reflectrons is configured to selectively operate in a first mode or a second mode, wherein the reflecting time of an ion from the reflectron 23A/23B in the first mode is longer than the reflecting time of that ion in the second mode 23A/23B, wherein the device 20 is configured such that an output of the charge detector is used to selectively change the mode of the reflectron(s) 23A/23B.

In one embodiment, similar to those illustrated in FIGS. 1 and 2, the ion flux 100 is received through entrance 26 to the ion trap 22. The ion flux then passes through the first reflection 23A, initially operating in a transmission mode, and then through the charge detector 24. The second reflectron 23B is operable in a first mode and second mode, as noted above. Initially, it is operated in its first mode, and serves to reflect the ion flux back through the charge detector 24. If the ion flux passing through the charge detector 24 (the first time) is determined to contain at least one ion of interest, the first reflectron 23A is configured to a trapping mode, thereby trapping the at least one ion of interest in the ion trap 22. Thereafter, the second reflectron 23B may be changed to its second mode.

The benefit of the second reflectron 23B being operated in a first and second mode is that the time take for a given ion to be reflected by the second reflection 23B may be selectively changed. When an ion of interest is being sought, the second reflectron 23B serves to delay the passage of the ion flux through the ion trap 22. Whereas when at least one ion of interest is identified, the second reflectron 23B can be reconfigured so as to operate without an undue delay.

In one embodiment, the second reflectron 23B may comprise a series of electrodes, which may be selectively controllable to determine the time taken for a given ion to be reflected thereby. The series of electrodes may be more elongated than those of a conventional reflectron. The potential applied to the electrodes may be configured to selectively provide a relatively delayed reflection, or a relatively fast reflection.

In an alternative, as schematically illustrated in FIG. 4A, the second reflectron 23B may be comprised of two components: a reflectron 30 and an ion mirror 31. The reflectron 30 may be substantially similar to the first reflection 23A at the entrance to the ion trap 22, operable in both a transmission mode and trapping mode. The ion mirror 31 is arranged adjacent to the reflectron 30 such that, when the reflectron 30 is operated in a transmission mode, ions pass through the reflectron 30 and are reflected by the ion mirror 31. Consequently, ions take longer to be reflected by the second reflectron 23b (comprising a reflectron 30 and ion mirror 31), increasing the time available to analyse the ion flux 100. However, when the second reflectron 23B is operated in the trapping mode, the ions are reflected back from the second reflectron 23B without passing through to the ion mirror 31.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A charge detection mass spectrometry device comprising:
an ion trap for receiving an ion flux and configured for selectively trapping and analysing one or more ions of interest from the ion flux, and
at least one primary charge detector, positioned upstream of the ion trap in the path of the ion flux, to analyse the ion flux,
wherein the device is configured such that the analysis by the at least one primary charge detector is used to selectively initiate an ion trapping event in the ion trap.

2. A charge detection mass spectrometry device according to claim 1, wherein the trapping event comprises trapping a detected one or more ions of interest in the ion trap.

3. A charge detection mass spectrometry device according to claim 1, wherein the distance between the primary charge detector and the ion trap is equal to or greater than the axial length of the ion trap.

4. A charge detection mass spectrometry device according to claim 1, wherein the ion trap comprises a secondary charge detector, for analysing one or more ions of interest trapped in the ion trap.

5. A charge detection mass spectrometry device according to claim 4, wherein the secondary charge detector is operable to analyse the ion flux and wherein the analysis by the at least one primary charge detector and the secondary charge detector is used to selectively initiate the ion trapping event in the ion trap.

6. A charge detection mass spectrometry device according to claim 4, wherein the inner diameter of the primary charge detector is smaller than the inner diameter of the secondary charge detector.

7. A charge detection mass spectrometry device according to claim 4, wherein the axial length of the primary charge detector is smaller than the axial length of the secondary charge detector.

8. A charge detection mass spectrometry device according to claim 1, wherein the primary charge detector comprises a plurality of detector electrodes.

9. A charge detection mass spectrometry device according to claim 8, wherein the axial length and/or inner diameter of at least one of the plurality of detector electrodes of the primary charge detector differs to the axial length and/or inner diameter of the or another of the plurality of detector electrodes of the primary charge detector.

10. A charge detection mass spectrometry device according to claim 8, wherein the primary charge detector comprises at least three detector electrodes axially spaced asymmetrically.

11. A charge detection mass spectrometry device according to claim 1, wherein the device comprises a first electrostatic lens located upstream of the primary charge detector and a second electrostatic lens located between the primary charge detector and the ion trap.

12. A charge detection mass spectrometry device according to claim 1, further comprising a controller operatively connected to the ion trap and the primary charge detector, the controller configured to detect one or more ions of interest passing the primary charge detector and to send a trigger signal to the ion trap to initiate the ion trapping event.

13. A charge detection mass spectrometry device according to claim 1, wherein the ion trap comprises a first reflectron and a second reflectron, and the trapping event comprises increasing the potential of the first and/or second reflectrons to trap said one or more ions of interest in the ion trap.

14. A charge detection mass spectrometry device according to claim 13, wherein the ion flux is received in the ion trap through the first reflectron, the first reflection being selectively operable in a transmission mode, allowing the passage of ions therethrough, and a trapping mode, substantially preventing the passage of ions therethrough, wherein the initiation of the trapping event comprises changing the first reflectron from said transmission mode to said trapping mode.

15. A charge detection mass spectrometry device according to claim 13, further comprising a secondary charge detector between the first and second reflectrons, for analysing one or more ions of interest trapped in the ion trap.

16. A method of charge detection mass spectrometry comprising:
providing an ion trap, and a primary charge detector upstream of the ion trap;
passing an ion flux through the primary charge detector and ion trap;
analysing the ion flux at the primary charge detector for one or more ions of interest; and
initiating an ion trapping event in the ion trap based on the analysis of the ion flux at the primary charge detector.

17. A method according to claim 16, wherein the ion trap comprises a first reflectron and a second reflectron, and initiating an ion trapping event comprises increasing the potential of the first and/or second reflectrons to trap said one or more ions of interest in the ion trap.

18. A charge detection mass spectrometry device comprising:
an ion trap for receiving an ion flux and configured for selectively trapping and analysing one or more ions from the ion flux, the ion trap comprising first and second reflectrons and at least one charge detector positioned between the first and second reflectrons,
wherein at least one of the first and second reflectrons is configured to selectively operate in a first mode or a second mode, wherein the reflecting time of an ion from the reflectron in the first mode is longer than the reflecting time of that ion in the second mode, wherein the device is configured such that an output of the charge detector is used to selectively change the mode of the reflectron(s).

19. A charge detection mass spectrometry device according to claim 18, configured to change the reflectron(s) from the first mode to the second mode upon detection by the charge detector of at least one ion of interest.

20. A charge detection mass spectrometry device according to claim 18, wherein at least one of the first and second reflectrons comprises first and second reflectron modules, the first reflectron module arranged between the charge detector and the second reflectron module,
the first reflectron module is selectively operable in a transmission mode, allowing the passage of ions therethrough, and a trapping mode, substantially preventing the passage of ions therethrough,
the second reflectron module configured to reflect any ions passing through the first reflectron module.

21. (canceled)
